(19) United States
(12) Patent Application Publication
(10) Pub. No.: US 2021/0194901 A1
(43) Pub. Date: Jun. 24, 2021

(54) ATTACK CANCELING DEVICE, ATTACK CANCELING METHOD, AND COMPUTER READABLE MEDIUM

(71) Applicant: Mitsubishi Electric Corporation, Tokyo (JP)

(72) Inventors: Shoei NASHIMOTO, Tokyo (JP); Daisuke SUZUKI, Tokyo (JP)

(73) Assignee: Mitsubishi Electric Corporation, Tokyo (JP)

(21) Appl. No.: 17/193,979

(22) Filed: Mar. 5, 2021

Related U.S. Application Data
(63) Continuation of application No. PCT/JP2018/043814, filed on Nov. 28, 2018.

(51) Int. Cl. H04L 29/06

(52) U.S. Cl. CPC H04L 63/1416; H04L 63/1483; H04L 63/1466

(57) ABSTRACT

An attack start time point identification unit (223) identifies an attack start time point at which an attack is started on a sensor (112) that outputs sensor data of each time point, based on the sensor data of each time point, the sensor data of each time point expressing a status at each time point of a control target (101) on which an actuator (111) operates. An attack canceling signal generation unit (224) generates an attack canceling signal series, being an actuator control signal series for restoring the status of the control target to a status of a time point that is before the attack start time point, based on at least one or the other of a sensor data series of since the attack start time point and an actuator control signal series of since the attack start time point.

### CROSS REFERENCE TO RELATED APPLICATION

This application is a Continuation of PCT International Application No. PCT/JP2018/043814, filed on Nov. 28, 2018, which is hereby expressly incorporated by reference into the present application.

### TECHNICAL FIELD

The present invention relates to a technique for canceling an attack on a sensor.

### BACKGROUND ART

An MEMS sensor is a sensor having a configuration in which mechanical components and electronic circuits are integrated as one assembly. Note that MEMS stands for Micro Electro Mechanical System.

MEMS sensors are often used because of their small size, high precision, and low cost. For example, MEMS gyro sensors and MEMS acceleration sensors are often used for autonomous driving of automobiles or autonomous control of robots.

In measurement or control using a sensor, a reliability of sensor data directly influences a reliability of a system. Therefore, an attack on the sensor is a threat. An attack that uses malware to deceive sensor data in a software manner can be dealt with by conventional information security technology.

On the other hand, a hardware attack that irradiates a sensor with a physical signal and physically fluctuates a status of the sensor cannot be dealt with by the conventional information security technology.

Non-Patent Literature 1 and Non-Patent Literature 2 disclose attack methods of deceiving a MEMS gyro sensor and a MEMS acceleration sensor, respectively, by ultrasonic waves.

A sound wave attack focuses on a fact that a MEMS sensor is composed of a spring and a weight. That is, a characteristic that an object composed of a spring and a weight has a resonance frequency is used. An attacker forcibly resonates a mechanical part of the MEMS sensor by irradiating the MEMS sensor with a sound wave having the same frequency as the resonance frequency of the MEMS sensor. As a result, an abnormal sensor output is obtained.

As a countermeasure against the sound wave attack on the MEMS sensor, the following defense methods are available.

Non-Patent Literature 1 discloses a countermeasure method that employs hardware. Specifically, Non-Patent Literature 1 discloses physically shielding the sensor, changing the resonance frequency of the sensor, and preparing a plurality of sensors of the same type and comparing sensor data.

Non-Patent Document 2 discloses a countermeasure method that uses hardware. Specifically, Non-Patent Document 2 discloses changing components that constitute the sensor with those that are less susceptible to an ultrasonic attack. Further, Non-Patent Document 2 discloses a countermeasure method that uses software. Specifically, Non-Patent Document 2 discloses changing of a sampling period of the sensor.

As a countermeasure against the sound wave attack on the MEMS sensor, the following detection method is available.

Non-Patent Literature 3 focuses on a fact that a MEMS gyro sensor and a MEMS acceleration sensor are often used together with a geomagnetic sensor, and discloses an attack detection method that uses software. Specifically, Non-Patent Literature 3 discloses detection of an attack by checking consistency of a physical status observed by various sensors.

Non-Patent Literatures 4 to 6 will be referred to in embodiments.

### CITATION LIST

### Non-Patent Literature

Non-Patent Literature 1: Son, Yunmok, et al. “Rocking drones with intentional sound noise on gyroscopic sensors.” 24th USENIX Security Symposium (USENIX Security 15). 2015.

Non-Patent Literature 2: Timothy Trippel, Ofir Weisse, Wenyuan Xu, Peter Honeyman, and Kevin Fu. 2017. WALNUT: Waging doubt on the integrity of mems accelerometers with acoustic injection attacks. In Security and Privacy (EuroS&P), 2017 IEEE European Symposium on. IEEE, 3-18.
Non-Patent Literature 3: NASHIMOTO, Shoei, et al. Sensor CON-Fusion: Defeating Kalman Filter in Signal Injection Attack. In: Proceedings of the 2018 on Asia Conference on Computer and Communications Security. ACM, 2018. p. 511-524.
Non-Patent Literature 4: Urbina, David I., et al. “Attacking Fieldbus Communications in ICS: Applications to the SWaT Testbed.” SG-CRC. 2016.
Non-Patent Literature 5: Ljung, Lennart. “System identification.” Signal analysis and prediction. Birkhauser, Boston, Mass., 1998. 163-173.
Non-Patent Literature 6: GREWAL, MOHINDER S., and ANGUS P. ANDREWS. “Kalman Filtering: Theory and Practice Using MATLAB.” (2001).

### SUMMARY OF INVENTION

### Technical Problem

Non-Patent Literature 1 or Non-Patent Literature 2 discloses a countermeasure method that employs hardware. However, in this countermeasure method, the sensor itself needs to be processed, leading to an increased cost. Also, a method that includes covering the sensor can adversely affect other sensors. Therefore, measurement performance may be adversely affected.

Non-Patent Literature 2 discloses a countermeasure method that employs software. However, this countermeasure method has a problem of versatility that it can be applied only to a particular sensor. Specifically, the countermeasure method of changing the sampling period is premised on that the sensor user can set the sampling period of the sensor.

Non-Patent Literature 3 discloses an attack detection method that employs software. However, Non-Patent Literature 3 does not disclose a method of how to handle a detected attack. Therefore, a control target whose attack has been detected becomes abnormal.

An objective of the present invention is to be able to cancel an attack on a sensor.

### Solution to Problem

An attack canceling device according to the present invention includes:

an attack start time point identification unit to identify an attack start time point at which an attack is started on a sensor that outputs sensor data of each time point, based on the sensor data of each time point, the sensor data of each time point expressing a status at each time point of a control target on which an actuator operates; and

an attack canceling signal generation unit to generate an attack canceling signal series, being an actuator control signal series for restoring the status of the control target to a status of a time point that is before the attack start time point, based on at least one or the other of a sensor data series of since the attack start time point and an actuator control signal series of since the attack start time point.

### Advantageous Effects of Invention

According to the present invention, an attack cancelation signal series can be generated. Then, an actuator operates according to the generated attack cancelation signal series, so that a control target is restored to a pre-attack status. That is, the attack on the sensor can be canceled.

### BRIEF DESCRIPTION OF DRAWINGS

FIG. 1 is a configuration diagram of an attack canceling system 100 in Embodiment 1.

FIG. 2 is a configuration diagram of an attack canceling device 200 in Embodiment 1.

FIG. 3 is a sequence diagram related to an actuator 111 and a sensor 112 in Embodiment 1.

FIG. 4 is a sequence diagram related to a controller 113 in Embodiment 1.

FIG. 5 is a sequence diagram related to an attack score calculation unit 211, an attack judgment unit 212, and an attack start time point identification unit 223 in Embodiment 1.

FIG. 6 is a sequence diagram related to an attack canceling signal generation unit 224 in Embodiment 1.

FIG. 7 is a sequence diagram related to a control signal output unit 230 in Embodiment 1.

FIG. 8 is an explanatory diagram about an attack start time point and an identifying threshold in Embodiment 1.

FIG. 9 is a flowchart illustrating operations of the attack start time point identification unit 223 in Embodiment 1.

FIG. 10 is a flowchart illustrating operations of the attack start time point identification unit 223 in Embodiment 1.

FIG. 11 is an explanatory diagram about an attack canceling signal series in Embodiment 1.

FIG. 12 is a flowchart of operations <First Method> of the attack canceling signal generation unit 224 in Embodiment 1.

FIG. 13 is a flowchart of an attack canceling signal generation process (S210) in Embodiment 1.

FIG. 14 is a flowchart of an attack canceling signal generation process (S220) in Embodiment 1.

FIG. 15 is a flowchart of a data series transformation process (S222) in Embodiment 1.

FIG. 16 is a flowchart of operations <Second Method> of the attack canceling signal generation unit 224 in Embodiment 1.

FIG. 17 is a flowchart of an attack canceling signal generation process (S320) in Embodiment 1.

FIG. 18 is a configuration diagram of an attack canceling system 100 in Embodiment 2.

FIG. 19 is a configuration diagram of an attack canceling device 200 in Embodiment 2.

FIG. 20 is a sequence diagram related to an interim control signal generation unit 241 in Embodiment 2.

FIG. 21 is a flowchart of operations [First Method] of the interim control signal generation unit 241 in Embodiment 2.

FIG. 22 is a flowchart of an interim control signal generation process (S420) in Embodiment 2.

FIG. 23 is a flowchart of operations [Second Method] of the interim control signal generation unit 241 in Embodiment 2.

FIG. 24 is a flowchart of an interim control signal generation process (S520) in Embodiment 2.

FIG. 25 is a sequence diagram related to a control signal output unit 230 in Embodiment 2.

FIG. 26 is a hardware configuration diagram of the attack canceling device 200 in Embodiments.

### DESCRIPTION OF EMBODIMENTS

In embodiments and drawings, the same element or equivalent element is denoted by the same reference sign. Description of an element denoted by the same reference sign as a described element will be appropriately omitted or simplified. Arrows in the drawings mainly illustrate data flows or process flows.

### Embodiment 1

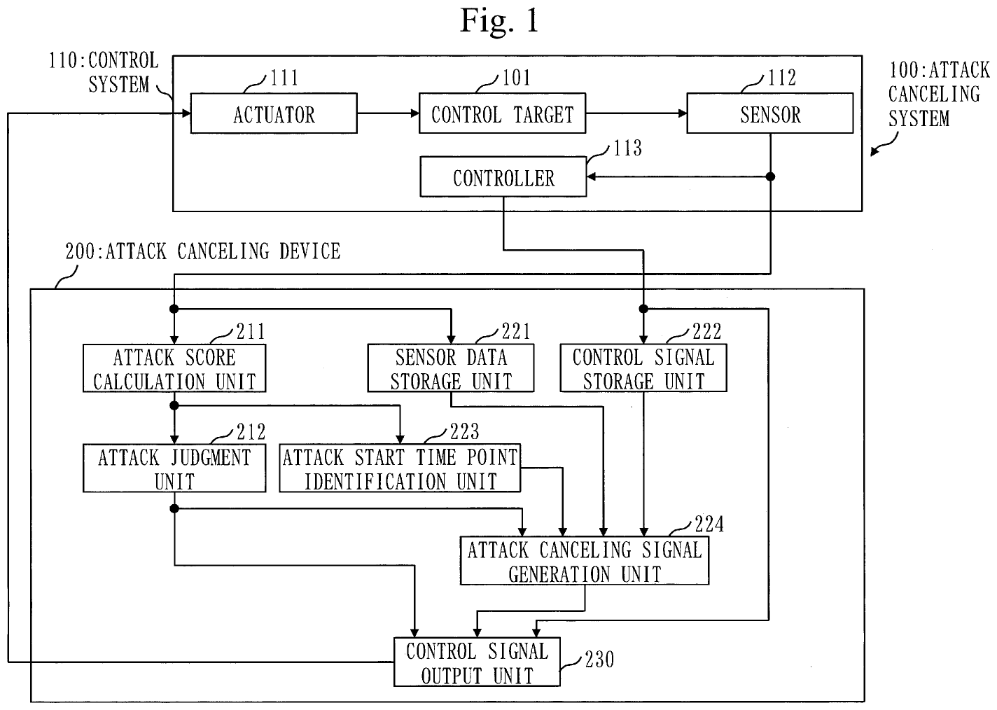

An attack canceling system 100 will be described with referring to FIGS. 1 to 17.

***Description of Configurations***

A configuration of the attack canceling system 100 will be described with referring to FIG. 1.

The attack canceling system 100 is provided with a control system 110 and an attack canceling device 200.

The control system 110 is provided with a control target 101, an actuator 111, a sensor 112, and a controller 113.

The control target 101 is an object which is a target (particularly an apparatus) to be controlled. For example, the control target 101 is a drone.

The actuator 111 is an actuator that operates on the control target 101. For example, if the control target 101 is a drone, the actuator 111 is a rotor.

The sensor 112 is a sensor to observe a status of the control target 101. For example, if the control target 101 is a drone, the sensor 112 is an inclination sensor that measures an inclination of the drone and a posture of the drone.

The controller 113 is a controller to control the control target 101. For example, if the control target 101 is a drone, the controller 113 is a flight controller.

The attack canceling device 200 is provided with an attack score calculation unit 211, an attack judgment unit 212, a sensor data storage unit 221, a control signal storage unit 222, an attack start time point identification unit 223, an attack canceling signal generation unit 224, and a control signal output unit 230.

Data flows and signal flows between elements will be described later.

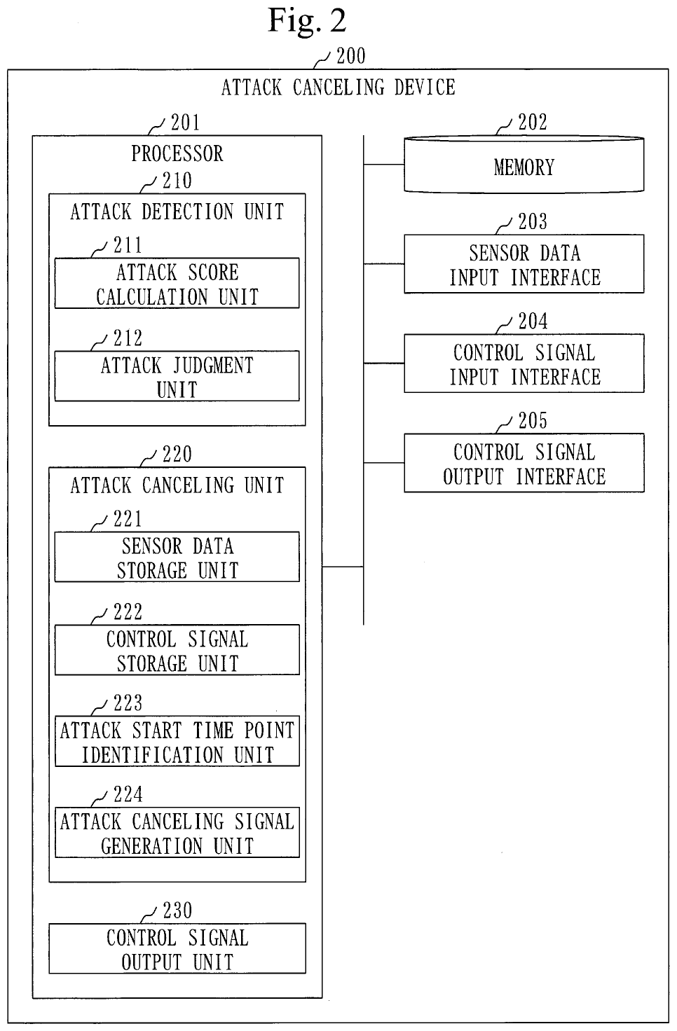

A configuration of the attack canceling device 200 will be described with referring to FIG. 2.

The attack canceling device 200 is a computer provided with hardware devices such as a processor 201, a memory 202, a sensor data input interface 203, a control signal input interface 204, and a control signal output interface 205. These hardware devices are connected to each other via signal lines.

The processor 201 is an Integrated Circuit to perform computation processing, and controls the other hardware devices. For example, the processor 201 is a CPU or a DSP. Note that CPU stands for Central Processing Unit, and DSP stands for Digital Signal Processor.

The memory 202 stores data. For example, the memory 202 is a RAM, a ROM, a flash memory, an HDD, or an SSD; or a combination of a RAM, a ROM, a flash memory, an HDD, and an SSD. Note that RAM stands for Random-Access Memory, ROM stands for Read-Only Memory, HDD stands for Hard Disk Drive, and SSD stands for Solid State Drive.

The sensor data input interface 203 is an interface to accept sensor data. For example, the sensor data input interface 203 is an I2C interface, an SPI, or an Ethernet interface. Note that I2C stands for Inter-Integrated Circuit, and SPI stands for Serial Peripheral Interface.

The control signal input interface 204 is an interface to accept an actuator control signal. For example, the control signal input interface 204 is an I2C interface, an SPI, or an Ethernet interface.

The control signal output interface 205 is an interface to output an actuator control signal. For example, the control signal output interface 205 is a Digital Analog Converter (DAC).

The actuator control signal is a signal to control the actuator 111.

Note that “Ethernet” is a registered trademark.

The attack canceling device 200 is provided with elements such as an attack detection unit 210, an attack canceling unit 220, and the control signal output unit 230. These elements are implemented by software.

The attack detection unit 210 is provided with an attack score calculation unit 211 and an attack judgment unit 212.

The attack canceling unit 220 is provided with the sensor data storage unit 221, the control signal storage unit 222, the attack start time point identification unit 223, and the attack canceling signal generation unit 224.

An attack canceling program for causing the computer to function as the attack detection unit 210, the attack canceling unit 220, and the control signal output unit 230 is stored in the memory 202.

The processor 201 executes the attack canceling program while executing an OS. Note that OS stands for Operating System.

Data obtained by executing the attack canceling program is stored in a storage device such as the memory 202, a register in the processor 201, and a cache memory in the processor 201.

The attack canceling device 200 may be provided with a plurality of processors that substitute for the processor 201. The plurality of processors share a role of the processor 201.

The attack canceling program can be computer readably recorded (stored) in a nonvolatile recording medium such as an optical disk and a flash memory.

***Description of Operations***

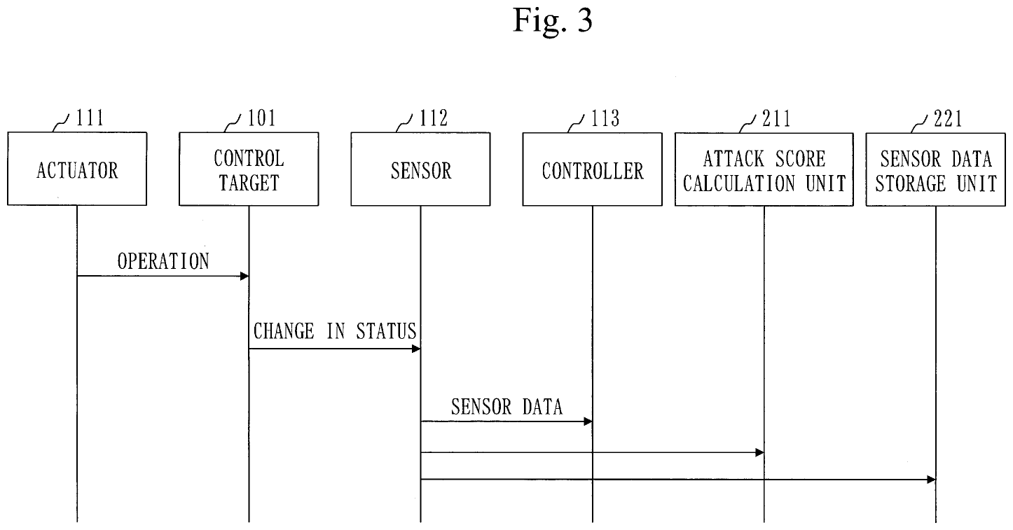

Operations of the attack canceling system 100 (particularly the attack canceling device 200) correspond to an attack canceling method. A procedure of the attack canceling method corresponds to a procedure of the attack canceling program. The operations of the attack canceling system 100 will be described with referring to FIGS. 3 to 7.

Operations of each of the actuator 111, the sensor 112, and the sensor data storage unit 221 will be described with referring to FIG. 3.

The actuator 111 operates in accordance with an actuator control signal outputted from the control signal output unit 230 to be described later. Consequently, the actuator 111 operates on the control target 101.

The sensor 112 measures the status of the control target 101 at each time point. Consequently, the sensor 112 observes a change in status of the control target 101. The sensor 112 outputs sensor data at each time point. The sensor data expresses a time point and a status value. The status value expresses the status of the control target 101.

The sensor data outputted from the sensor 112 is inputted to each of the controller 113, the attack score calculation unit 211, and the sensor data storage unit 221.

The sensor data is inputted to sensor data storage unit 221 at each time point from the sensor 112. The sensor data storage unit 221 accepts the inputted sensor data.

The sensor data storage unit 221 stores the accepted sensor data to the memory 202 successively.

As a capacity of the memory 202 is limited, the sensor data storage unit 221 may employ a storing method such as a ring buffer.

The ring buffer has a data structure as follows. Every piece of data is saved in the ring buffer until a size of the entire stored data reaches a default size. However, when the size of the stored data exceeds the default size, overwriting on the stored data is performed sequentially starting with an oldest piece of data.

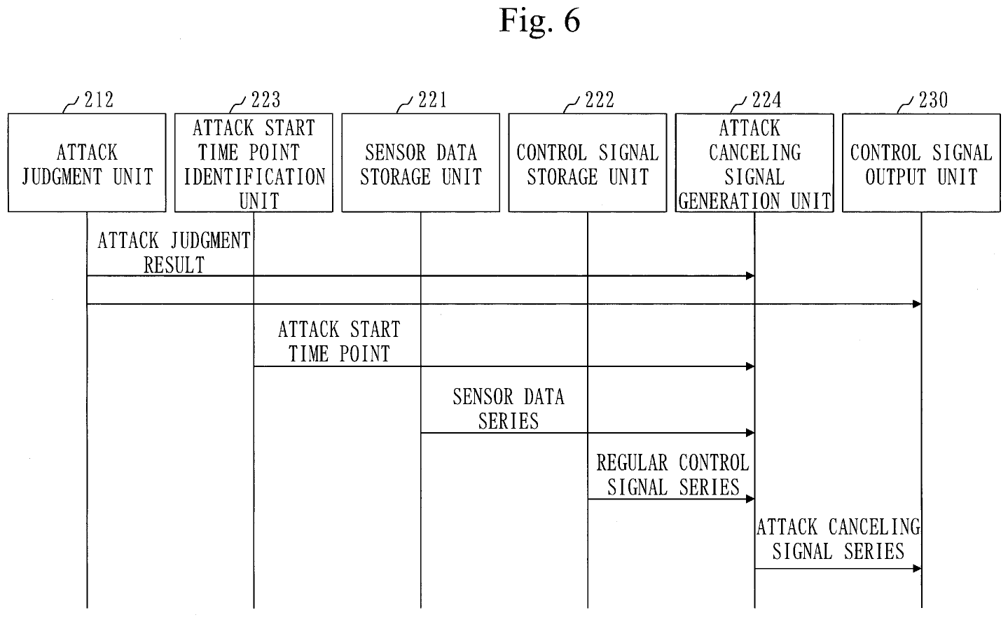

The sensor data storage unit 221 outputs a sensor data series stored in the memory 202 (see FIG. 6).

The sensor data series outputted from the sensor data storage unit 221 is inputted to the attack canceling signal generation unit 224.

The sensor data series is composed of one piece of sensor data or more lining up in a time-base order.

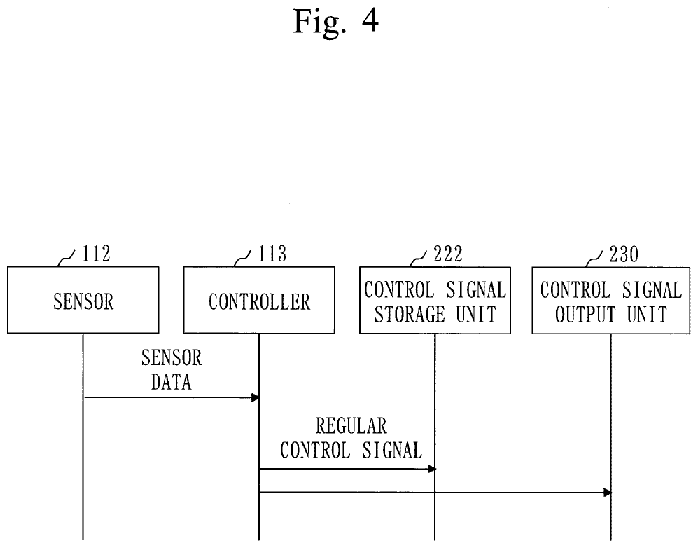

Operations of each of the controller 113 and the control signal storage unit 222 will be described with referring to FIG. 4.

A control algorithm to control the actuator 111 is set in the controller 113 in advance.

The sensor data is inputted to the controller 113 at each time point from the sensor 112. The controller 113 accepts the inputted sensor data.

The controller 113 executes the control algorithm on the accepted sensor data. Consequently, the actuator control signal is generated.

Assume that the control target 101 is a drone, the actuator 111 is a rotor, and the sensor 112 is an inclination sensor. In this case, inclination data expressing an inclination of the drone is inputted to the controller 113. Then, the controller 113 generates a control signal for the rotor based on the inclination data. The control signal for the rotor is a PWM signal or an alternating-current signal. Note that PWM stands for Pulse Width Modulation.

The actuator control signal generated by the controller 113 will be called a “regular control signal”.

The controller 113 outputs the generated regular control signal.

The regular control signal outputted from the controller 113 is inputted to each of the control signal storage unit 222 and the control signal output unit 230.

The regular control signal is inputted to the control signal storage unit 222 at each time point from the controller 113. The control signal storage unit 222 accepts the inputted regular control signal.

The control signal storage unit 222 stores the accepted regular control signal to the memory 202. Note that a signal is converted into data and stored.

As the capacity of the memory 202 is limited, the control signal storage unit 222 may employ a storing method such as a ring buffer.

The control signal storage unit 222 outputs a stored regular control signal series, through the memory 202 (see FIG. 6).

The regular control signal series outputted from the control signal storage unit 222 is inputted to the attack canceling signal generation unit 224.

The regular control signal series is composed of one regular control signal or more lining up in a time-point order.

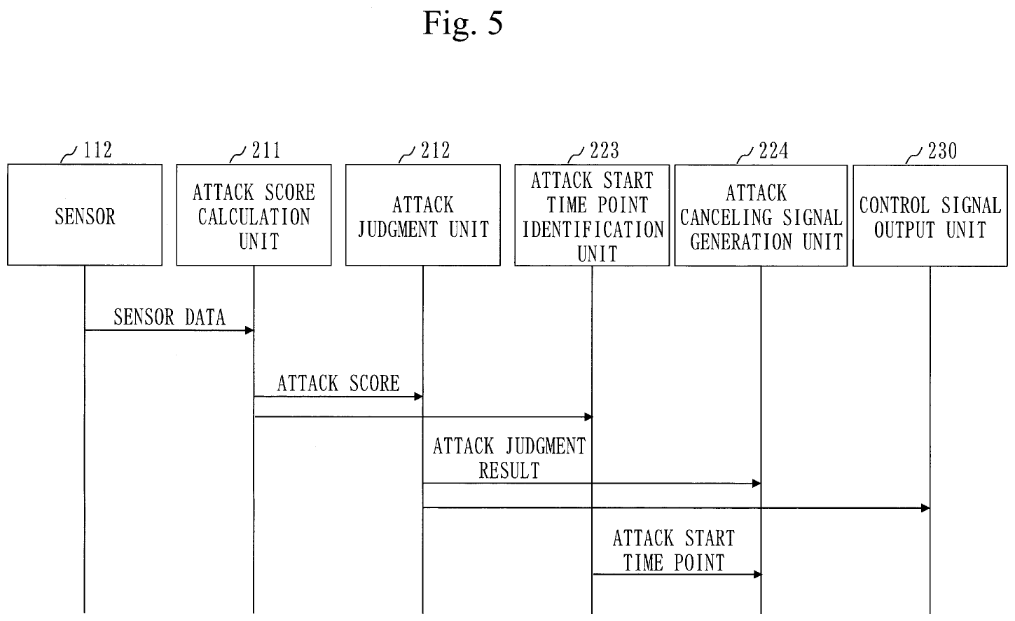

Operations of each of the attack score calculation unit 211, the attack judgment unit 212, and the attack start time point identification unit 223 will be described with referring to FIG. 5.

The sensor data is inputted to the attack score calculation unit 211 at each time point from the sensor 112. The attack score calculation unit 211 accepts the inputted sensor data.

The attack score calculation unit 211 extracts an attack feature from the accepted sensor data and calculates an attack score based on the extracted attack feature.

The attack feature is a feature appearing in the sensor data when an attack is being made.

The attack score expresses a height of possibility that an attack is being made.

The attack score can be calculated by a conventional method. For example, the attack score calculation unit 211 calculates the attack score by a method disclosed in Non-Patent Literature 3.

In the method disclosed in Non-Patent Literature 3, various sensors are used, and an inconsistency in a physical status is verified based on various sensor data.

Specifically, Non-Patent Literature 3 discloses an attack detection method which employs an inclination sensor called AHRS. The AHRS is formed of a gyro sensor, an acceleration sensor, and a magnetic sensor. Note that AHRS stands for Attitude Heading Reference System. Each of the gyro sensor and the acceleration sensor can measure gravity. Each of the gyro sensor and the magnetic sensor can measure geomagnetism. Accordingly, it is possible to find an error between two gravities measured by two methods, and an error between two magnetisms measured by two methods. When a sensor is attacked, these errors increase. Accordingly, the attack can be detected. Therefore, with the attack detection method of Non-Patent Literature 3, the attack score represents an error between two gravities measured by the two methods, and an error between two magnetisms measured by the two methods.

The attack score calculation unit 211 outputs the calculated attack score.

The attack score outputted from the attack score calculation unit 211 is inputted to each of the attack judgment unit 212 and the attack start time point identification unit 223.

The attack score is inputted to the attack judgment unit 212 at each time point from the attack score calculation unit 211. The attack judgment unit 212 accepts the inputted attack score.

The attack judgment unit 212 judges whether or not an attack on the sensor 112 exists based on sensor data of each time point. As the attack score of each time point is calculated based on the sensor data of each time point, it is possible to paraphrase that the attack judgment unit 212 judges whether or not an attack at each time point exists based on the sensor data of each time point.

For example, a judging threshold is set in advance. The attack judgment unit 212 compares the attack score with the judging threshold and judges whether or not an attack exists based on a comparison result.

If, for example, the attack score is higher than the judging threshold, the attack judgment unit 212 judges that “an attack exists”. “An attack exists” signifies that an attack is being made.

Non-Patent Literature 4 describes calculation of an attack score which is based on sensor data, and an attack judgment method which uses a threshold.

The attack judgment unit 212 outputs an attack judgment result.

The attack judgment result outputted from the attack judgment unit 212 is inputted to each of the attack canceling signal generation unit 224 and the control signal output unit 230.

The attack score is inputted to the attack start time point identification unit 223 at each time point from the attack score calculation unit 211. The attack start time point identification unit 223 accepts the inputted attack score.

The attack start time point identification unit 223 identifies the time point at which the attack is started on the sensor 112, based on the attack score of each time point. As the attack score of each time point is calculated based on the sensor data of each time point, it is possible to paraphrase that the attack start time point identification unit 223 identifies an attack start time point based on the sensor data of each time point.

For example, an identifying threshold is set in advance. Then, the attack start time point identification unit 223 compares the attack score with the identifying threshold and judges whether or not an attack exists based on a comparison result.

For example, the attack start time point identification unit 223 identifies a time point at which the attack score exceeds the identifying threshold, as the attack start time point.

In this case, the identifying threshold used by the attack start time point identification unit 223 is lower than the judging threshold used by the attack judgment unit 212. That is, the threshold of the attack start time point identification unit 223 has a higher sensitivity than that of the threshold of the attack judgment unit 212.

When the attack start time point identification unit 223 is to identify the attack start time point in accordance with the same method as the method of the attack judgment unit 212, the threshold of the attack start time point identification unit 223 must have a higher sensitivity than that of the threshold of the attack judgment unit 212. The difference in sensitivity of the threshold results from the following.

In attack detection, it is necessary to reduce erroneous detection.

Accordingly, the threshold must have a certain degree of margin. In this case, however, although a time point at which the start becomes apparent is obtained, a time point at which the attack is started is cannot be obtained. In view of this, the sensitivity of the threshold for identifying the attack start time point is increased. Hence, a time point closer to the time point at which the attack is actually started can be identified.

It is anticipated that as the threshold for attack detection, a value will be set according to which erroneous detection becomes the smallest under a condition that the control target 101 does not become abnormal even if the control target 101 is attacked. After an attack is detected, however, if no countermeasure is taken against the attack, the status of the control target 101 will possibly become abnormal. This is due to the following: after the attack is started, the sensor 112 becomes unusable at all, so that its spontaneous recovery cannot be expected.

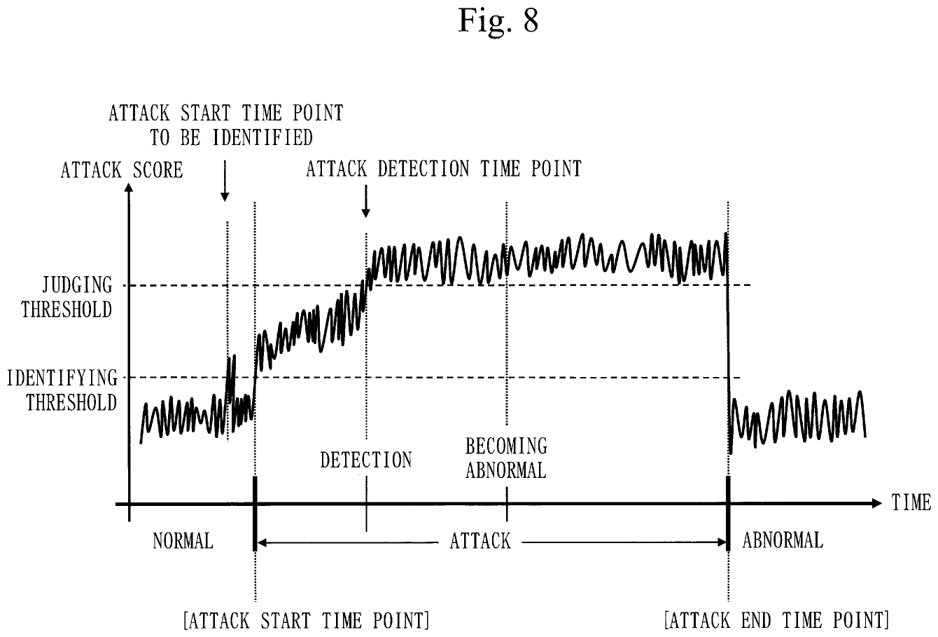

A difference between the judging threshold and the identifying threshold will be described with referring to FIG. 8.

The judging threshold is a threshold used by the attack judgment unit 212. In other words, the judging threshold is a detection criterion in the attack detection unit 210.

The identifying threshold is a threshold used by the attack start time point identification unit 223. In other words, the identifying threshold is an identifying criterion in the attack start time point identification unit 223.

The [attack start time point] is a time point at which the attack is actually started.

The [attack end time point] is a time point at which the attack is actually ended.

The axis of abscissa represents the time, and the axis of ordinate represents the attack score.

Referring to FIG. 8, an attack is started at a certain time point, the attack is detected at a certain time point, the control target 101 becomes abnormal at a certain time point, and the attack ends at a certain time point.

The identifying threshold is lower than the judging threshold. That is, the identifying threshold has a high sensitivity. Hence, the attack start time point is identified to fall within a normal time frame. When an attack is actually started, the attack score increases. At a certain time point, the attack score exceeds the judging threshold, and the attack is detected.

As illustrated in FIG. 8, there is a possibility that an attack start time point to be identified falls on a time point that is before the actual attack start time point. However, the status of the control target 101 at the identified attack start time point is normal. Hence, there is no problem in restoring the status of the control target 101 to the status of the identified attack start time point. On the contrary, if the attack start time point falls on a time point that is later than the actual attack start time point, the status of the control target 101 at the identified attack start time point is abnormal. Hence, a problem arises in recovering the status of the control target 101 to the status of the identified attack start time point. Therefore, a time point before the actual attack start time point must be identified as the attack start time point.

In view of this, a threshold having a higher sensitivity than that of the judging threshold is used as the identifying threshold.

Furthermore, the attack start time point identification unit 223 stores, for a predetermined period of time, the time point at which the attack score exceeds the identifying threshold. The reason is as follows.

After the start of the attack, if the attack score fluctuates and falls below the identifying threshold value even by a little, the time point at which the attack score exceeds the identifying threshold will be reset unless the time point at which the attack score exceeded the identifying threshold before the start of the attack has been memorized for a certain period of time. Accordingly, the attack start time point to be identified will undesirably fall on a time point that is later than the actual attack start time point.

In view of this, the attack start time point identification unit 223 uses a beyond-threshold counter.

The beyond-threshold counter is a counter for storing, for a certain period of time, a time point at which the attack score has exceeded the identifying threshold.

If the attack score does not exceed the identifying threshold, the attack start time point identification unit 223 decrements the beyond-threshold counter.

If the attack score does not exceed the identifying threshold for the certain period of time, the attack start time point identification unit 223 resets the attack start time point.

Consequently, the attack start time point that has been identified once can be stored for the certain period of time.

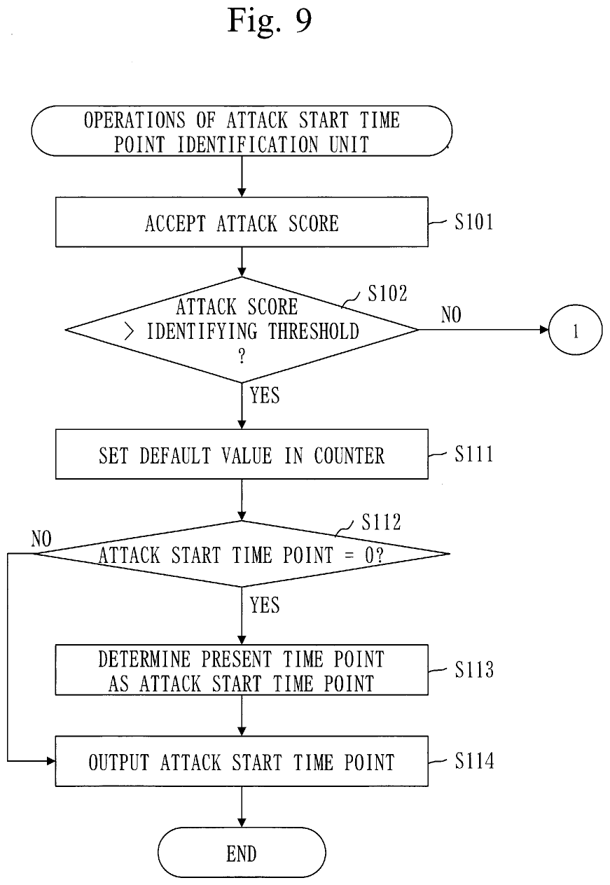

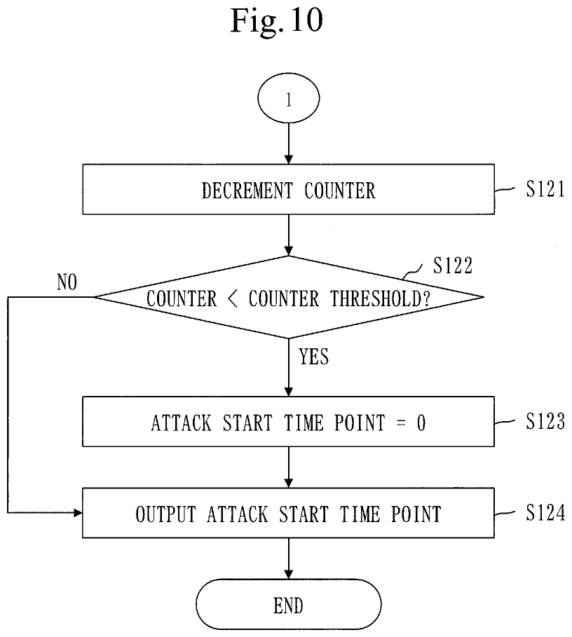

A procedure of the operations of the attack start time point identification unit 223 will be described with referring to FIGS. 9 and 10.

In step S101, the attack start time point identification unit 223 accepts an attack score.

In step S102, the attack start time point identification unit 223 compares the attack score with the identifying threshold.

If the attack score is higher than the identifying threshold, the processing proceeds to step S111.

If the attack score is equal to or less than the identifying threshold, the processing proceeds to step S121.

In step S111, the attack start time point identification unit 223 sets a default value in the beyond-threshold counter.

In step S112, the attack start time point identification unit 223 judges whether the attack start time point is in a reset status (0).

If the attack start time point is in a reset status, it is estimated that the attack is ongoing. In this case, the attack start time point is not changed, and the processing proceeds to step S113.

If the attack start time point is not in a reset status, that is, if the attack start time point is a certain time point, the processing proceeds to step S114.

In step S113, the attack start time point identification unit 223 determines the present time point as the attack start time point.

In step S114, the attack start time point identification unit 223 outputs the attack start time point.

After step S114, the processing ends.

In step S121, the attack start time point identification unit 223 decrements the beyond-threshold counter.

In step S122, the attack start time point identification unit 223 compares a value on the beyond-threshold counter with a counter threshold. The counter threshold is a predetermined value. For example, the counter threshold is 0.

If the value on the beyond-threshold counter is smaller than the counter threshold, the processing proceeds to step S123.

If the value on the beyond-threshold counter is equal to or larger than the counter threshold, the processing proceeds to step S124.

In step S123, the attack start time point identification unit 223 resets the attack start time point. Specifically, the attack start time point identification unit 223 determines “0” as the attack start time point.

In step S124, the attack start time point identification unit 223 outputs the attack start time point.

After step S124, the processing ends.

Back to FIG. 5, the description of the attack start time point identification unit 223 will continue.

The attack start time point identification unit 223 outputs the identified attack start time point.

The attack start time point outputted from the attack start time point identification unit 223 is inputted to the attack canceling signal generation unit 224.

Operations of the attack canceling signal generation unit 224 will be described with referring to FIG. 6.

The attack judgment result is inputted to the attack canceling signal generation unit 224 at each time point from the attack judgment unit 212. The attack canceling signal generation unit 224 accepts the inputted attack judgment result.

The attack start time point is inputted to the attack canceling signal generation unit 224 at each time point from the attack start time point identification unit 223. The attack canceling signal generation unit 224 accepts the inputted attack start time point. The sensor data series is inputted to the attack canceling signal generation unit 224 from the sensor data storage unit 221. The attack canceling signal generation unit 224 accepts the inputted sensor data series.

The regular control signal series is inputted to the attack canceling signal generation unit 224 from the control signal storage unit 222. The attack canceling signal generation unit 224 accepts the inputted regular control signal series.

The attack canceling signal generation unit 224 generates an attack canceling signal series based on the attack judgment result, the attack start time point, the sensor data series, and the regular control signal series.

The attack canceling signal series is composed of one attack canceling signal or more lining up on the time base.

The attack canceling signal is an actuator control signal for restoring the status of the control target 101 to a normal status.

Note that the attack canceling signal generation unit 224 may generate the attack canceling signal series using one or the other of the sensor data series and the regular control signal series.

A method that uses the sensor data series and not the regular control signal series will be called a <First Method>. In the <First Method>, the control signal storage unit 222 is unnecessary.

A method that uses the regular control signal series but not the sensor data series will be called a <Second Method>. In the <Second Method>, the sensor data series is not necessary as a whole, but sensor data of a time point before the attack start time point is necessary.

A method that uses both of the sensor data series and the regular control signal series will be called a <Third Method>.

The <First Method> will be described.

In the <First Method>, a sensor data series is inverted, and an actuator control signal is generated by tracing the inverted sensor data series backward. The actuator control signal to be generated is the attack canceling signal series.

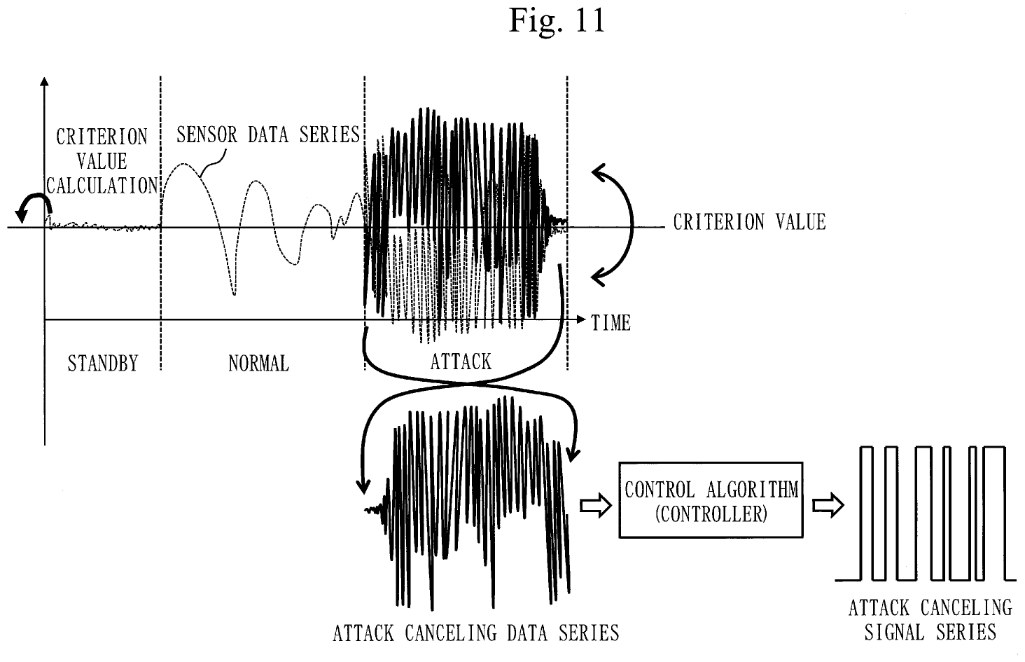

An outline of the <First Method> will be described with referring to FIG. 11.

A dotted-line waveform expresses an accepted sensor data series.

A solid-line waveform expresses a processed sensor data series.

The axis of abscissa represents the time, and the axis of ordinate represents a value of sensor data.

First, after the control target 101 is started, the control target 101 is made to stand by, so that the control target 101 is set in a stable status.

Then, the attack canceling signal generation unit 224 determines a criterion value based on the standby sensor data series.

The criterion value is a value that expresses the status of the standby control target 101.

Subsequently, the attack canceling signal generation unit 224 extracts a sensor data series of since the attack start time point, from the accepted sensor data series. The sensor data series to be extracted will be referred to as an “abnormal data series”.

Subsequently, the attack canceling signal generation unit 224 folds back the abnormal data series with respect to a criterion value axis. As a result, an abnormal data series whose physical significance is inverted is obtained.

Furthermore, the attack canceling signal generation unit 224 reverses an order of the abnormal data series along the time axis. That is, the attack canceling signal generation unit 224 changes the old-to-new line-up order of the values in the abnormal data series to a new-to-old line-up order.

The processed abnormal data series will be called an “attack canceling data series”.

Then, the attack canceling signal generation unit 224 executes a control algorithm on the attack canceling data series. As a result, an attack canceling signal series is generated.

The control algorithm to be executed by the attack canceling signal generation unit 224 is the same as the control algorithm executed by the controller 113.

The attack canceling signal series is composed of one attack canceling signal or more lining up on the time base. The attack canceling signal series has a time width just as the abnormal data series does.

The <First Method> is particularly effective when the sensor data series has linearity. This is because additivity is valid when the sensor data series has linearity.

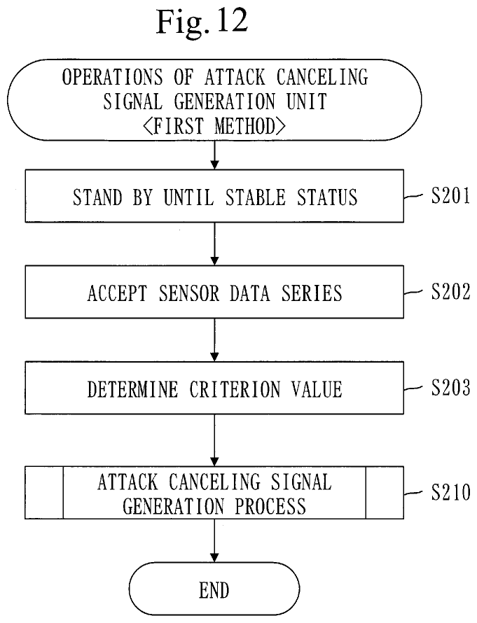

A procedure of the <First Method> will be described with referring to FIG. 12.

In step S201, the attack canceling signal generation unit 224 stands by until the control target 101 becomes stable.

Specifically, the attack canceling signal generation unit 224 stands by until a certain period of time lapses after the control target 101 is started.

In step S202, the attack canceling signal generation unit 224 accepts the standby sensor data series.

In step S203, the attack canceling signal generation unit 224 determines a criterion value based on the standby sensor data series.

For example, the attack canceling signal generation unit 224 calculates a mean, a median, or a mode of the standby sensor data series. The value to be calculated is the criterion value.

Step S201 to step S203 may be executed only when the control target 101 is started.

In step S210, the attack canceling signal generation unit 224 generates an attack canceling signal series using the determined criterion value.

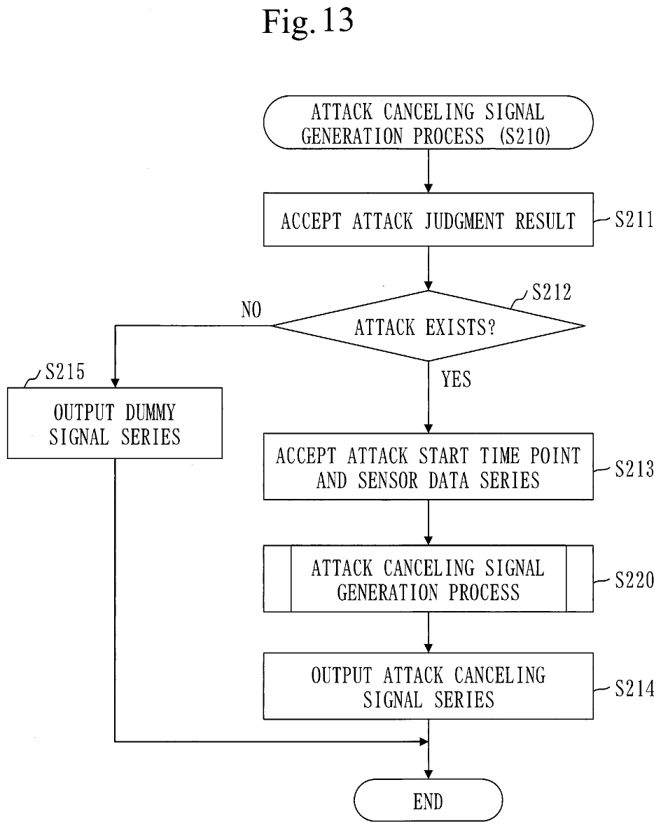

A procedure of an attack canceling signal generation process (S210) will be described with referring to FIG. 13.

In step S211, the attack canceling signal generation unit 224 accepts an attack judgment result.

In step S212, the attack canceling signal generation unit 224 judges whether or not an attack exists based on the attack judgment result.

If it is judged that “an attack exists”, the processing proceeds to step S213.

If it is judged that “an attack does not exist”, the processing proceeds to step S215.

In step S213, the attack canceling signal generation unit 224 accepts an attack start time point and a sensor data series.

In step S220, the attack canceling signal generation unit 224 generates an attack canceling signal series based on the attack start time point accepted in step S213, the sensor data series accepted in step S213, and the criterion value determined in step S203.

A procedure of the attack canceling signal generation process (S220) will be described later.

In step S214, the attack canceling signal generation unit 224 outputs the attack canceling signal series.

Specifically, the attack canceling signal generation unit 224 outputs one attack canceling signal or more included in the attack canceling signal series, one by one in the time-base order.

After step S214, the attack canceling signal generation process (S210) ends.

In step S215, the attack canceling signal generation unit 224 outputs a dummy signal series as the attack canceling signal series.

The dummy signal series is composed of one dummy value or more. The dummy value may take any value. For example, the dummy value is “0”.

After step S215, the attack canceling signal generation process (S210) ends.

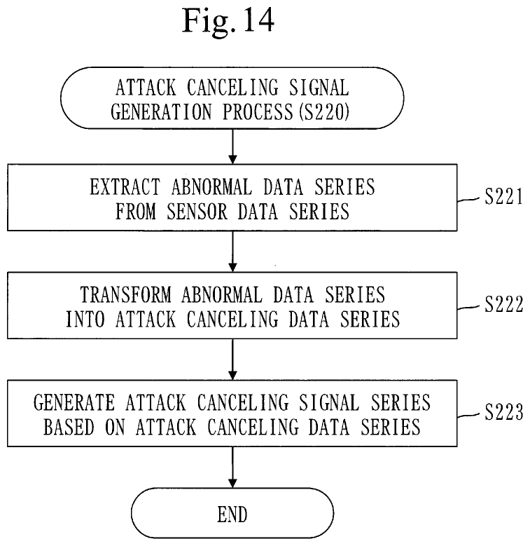

The procedure of the attack canceling signal generation process (S220) will now be described with referring to FIG. 14.

In step S221, the attack canceling signal generation unit 224 extracts a sensor data series of since the attack start time point, from the sensor data series accepted in step S213.

The sensor data series to be extracted will be referred to as an “abnormal data series”.

Note that the attack canceling signal generation unit 224 may extract a sensor data series of since a time point that is before the attack start time point. As a result, the status of the control target 101 can be restored to a status of a time point that is before the attack start time point.

In step S222, the attack canceling signal generation unit 224 transforms the abnormal data series into an attack canceling data series.

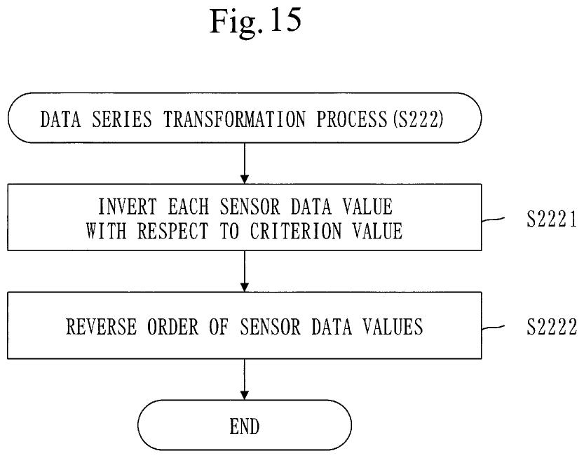

A data series transformation process (S222) will be described with referring to FIG. 15.

In step S2221, the attack canceling signal generation unit 224 inverts each sensor data value of the abnormal data series with respect to the criterion value.

Specifically, the attack canceling signal generation unit 224 changes each sensor data value of the abnormal data series as follows with respect to the criterion value.

First, the attack canceling signal generation unit 224 subtracts the criterion value from the sensor data value.

Subsequently, the attack canceling signal generation unit 224 inverts a sign (plus/minus) of the post-subtraction sensor data value.

Then, the attack canceling signal generation unit 224 subtracts the criterion value from the sign-inverted sensor data value.

The post-subtraction sensor value data is the sensor data value inverted with respect to the criterion value.

Each sensor data value of the abnormal data series can be inverted with respect to the criterion value by executing expression (1).

Note that:

“S”′ represents a sensor data value inverted with respect to the criterion value;

“S” represents a sensor data value of the abnormal data series; and

“std” represents the criterion value.

$$\begin{matrix}{S}^{′} = - ( S - std ) + std \\ = 2 std - S\end{matrix} \qquad ( 1 )$$

In step S2222, the attack canceling signal generation unit 224 reverses the order of the sensor data values on the time base.

An abnormal data series after step S2222 is the attack canceling data series.

Back to FIG. 14, step S223 will be described.

In step S223, the attack canceling signal generation unit 224 executes a control algorithm on the attack canceling data series. An actuator control signal series thus generated is the attack canceling signal series.

The control algorithm executed in step S223 is the same as the control algorithm in the controller 113.

The <Second Method> will be described.

In the <Second Method>, a normal status of a control target 101 and a status of a control target 101 that has become abnormal due to erroneous control caused by an attack are compared to each other, so that an actuator control signal series to restore the abnormal status to the normal status is generated. The actuator control signal series to be generated is the attack canceling signal series.

In order to judge the normal status of the control target 101, the attack canceling signal generation unit 224 extracts a sensor data value of immediately before an attack start time point from an accepted sensor data series.

In order to speculate the abnormal status of the control target 101, the attack canceling signal generation unit 224 extracts a regular control signal series of since the attack start time point, from an accepted regular control signal series. The regular control signal series to be extracted will be referred to as an “abnormal control signal series”.

Then, the attack canceling signal generation unit 224 identifies in what abnormal status the status of the control target 101 is, by utilizing a status estimation algorithm.

Furthermore, the attack canceling signal generation unit 224 generates an actuator control signal series so that the control target 101 is restored from the abnormal status to the normal status. The actuator control signal series to be generated is the attack canceling signal series.

The <Second Method> is particularly effective when the sensor data series has nonlinearity.

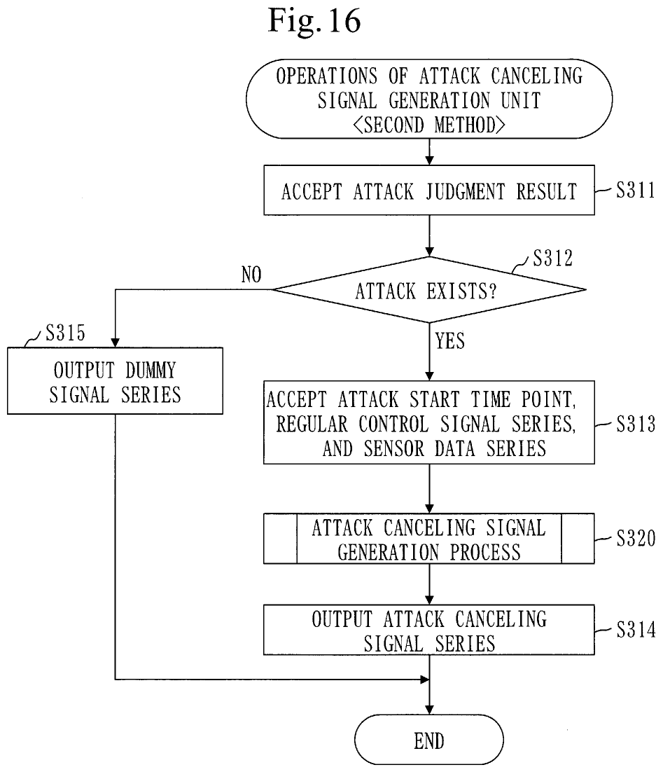

A procedure of the <Second Method> will be described with referring to FIG. 16.

In step S311, the attack canceling signal generation unit 224 accepts an attack judgment result.

In step S312, the attack canceling signal generation unit 224 judges whether or not an attack exists based on the attack judgment result.

If it is judged that “an attack exists”, the processing proceeds to step S313.

If it is judged that “an attack does not exist”, the processing proceeds to step S315.

In step S313, the attack canceling signal generation unit 224 accepts an attack start time point, a regular control signal series, and a sensor data series.

In step S320, the attack canceling signal generation unit 224 generates an attack canceling signal series based on the attack start time point, the regular control signal series, and the sensor data series.

A procedure of an attack canceling signal generation process (S320) will be described later.

In step S314, the attack canceling signal generation unit 224 outputs the attack canceling signal series.

Specifically, the attack canceling signal generation unit 224 outputs one attack canceling signal or more included in the attack canceling signal series, one by one in the time-base order.

After step S314, the processing ends.

In step S315, the attack canceling signal generation unit 224 outputs a dummy signal series as the attack canceling signal series.

The dummy signal series is composed of one dummy value or more. The dummy value may take any value. For example, the dummy value is “0”.

After step S315, the process ends.

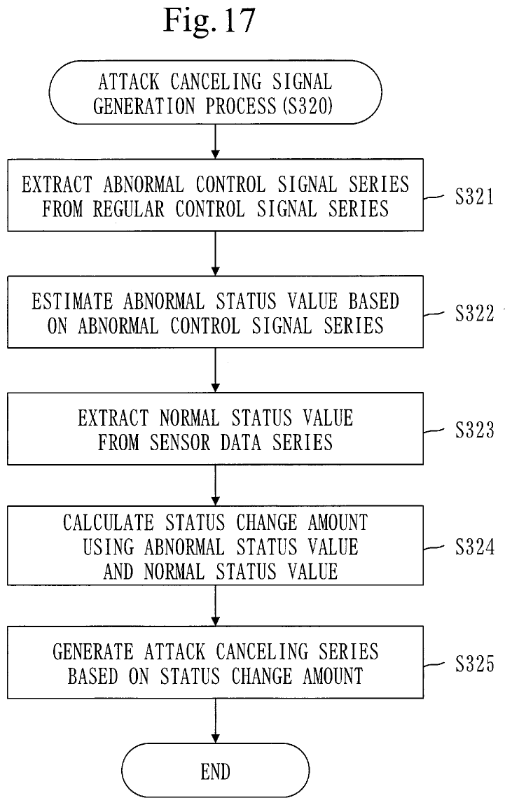

The procedure of the attack canceling signal generation process (S320) will now be described with referring to FIG. 17.

In step S321, the attack canceling signal generation unit 224 extracts a regular control signal series of since the attack start time point, from the regular control signal series accepted in step S313.

The regular control signal series to be extracted will be referred to as an “abnormal control signal series”.

Note that the attack canceling signal generation unit 224 may extract a regular control signal series of since a time point that is before the attack start time point. Consequently, the status of the control target 101 can be restored to a status of a time point that is before the attack start time point.

In step S322, the attack canceling signal generation unit 224 executes a status estimation algorithm using the abnormal control signal series. Consequently, a status of the present control target 101, that is, an abnormal status of the control target 101, is estimated. A value expressing an abnormal statue will be referred to as an “abnormal status value”.

For example, a status estimation device based on system identification, or a Kalman filter, can be utilized for executing the status estimation algorithm.

The status estimation device based on system identification is described in Non-Patent Literature 5.

The Kalman filter is described in Non-Patent Literature 6.

In step S323, the attack canceling signal generation unit 224 extracts sensor data of a time point that is before the attack start time point, from the sensor data series accepted in step S313. Specifically, the attack canceling signal generation unit 224 extracts sensor data of immediately before the attack start time point.

The sensor data to be extracted expresses a normal status of the control target 101. A value expressing the normal status will be referred to as a “normal status value”.

The attack canceling signal generation unit 224 may accept sensor data of a time point that is before the attack start time point, instead of accepting a sensor data series in step S313.

In step S324, the attack canceling signal generation unit 224 calculates a difference between the abnormal status value and the normal status value. The difference to be calculated will be referred to as a “status change amount”.

The status change amount is a change amount of from the status expressed by the sensor data extracted in step S323 to the status estimated in step S322.

In step S325, the attack canceling signal generation unit 224 generates an attack canceling signal series based on the status change amount.

Specifically, the attack canceling signal generation unit 224 generates an actuator control signal series that cancels the status change amount. That is, the attack canceling signal generation unit 224 generates an actuator control signal series for restoring the status of the control target 101 only by the status change amount. The actuator control signal series to be generated is the attack canceling signal series.

Assume that the control target 101 is a drone, the actuator 111 is a rotor, and the sensor 112 is an inclination sensor.

The inclination sensor measures inclination of the drone in a world coordinate system. The inclination of the drone in the world coordinate system is expressed by three values: roll, pitch, and yaw. In this case, an amount of rotation of the drone about a roll axis, a pitch axis, and a yaw axis is the status change amount.

The attack canceling signal generation unit 224 generates one actuator control signal or more that operate the rotor so as to inversely rotate the drone by the status change amount about the roll axis, the pitch axis, and the yaw axis. The one actuator control signal or more to be generated form the attack canceling signal series.

For example, when rotation of +10 degrees about any one axis out of the roll axis, the pitch axis, and the yaw axis is the status change amount, an actuator control signal to cause rotation of −10 degrees about that axis is the attack canceling signal.

The <Third Method> will now be described. In the <Third Method>, an attack canceling signal series is generated with using a sensor data series and a regular control signal series.

The attack canceling signal generation unit 224 generates the attack canceling signal series as follows.

First, the attack canceling signal generation unit 224 generates an attack canceling signal series by the <First Method> using a sensor data series. The attack canceling signal series to be generated will be referred to as a <First Candidate Series>.

Also, the attack canceling signal generation unit 224 generates an attack canceling signal series by the <Second Method> using a regular control signal series. The attack canceling signal series to be generated will be referred to as a <Second Candidate Series>.

Then, the attack canceling signal generation unit 224 generates an attack canceling signal series using the first candidate series and the second candidate series.

For example, the attack canceling signal generation unit 224 finds an average of a signal value of an attack canceling signal in the first candidate series and a signal value of an attack canceling signal in the second candidate series, in a time-series manner. A time series of the obtained average is the attack canceling signal series.

Back to FIG. 6, the description of the attack canceling signal generation unit 224 will continue.

The attack canceling signal generation unit 224 outputs the generated attack canceling signal series.

The attack canceling signal series outputted from the attack canceling signal generation unit 224 is inputted to the control signal output unit 230.

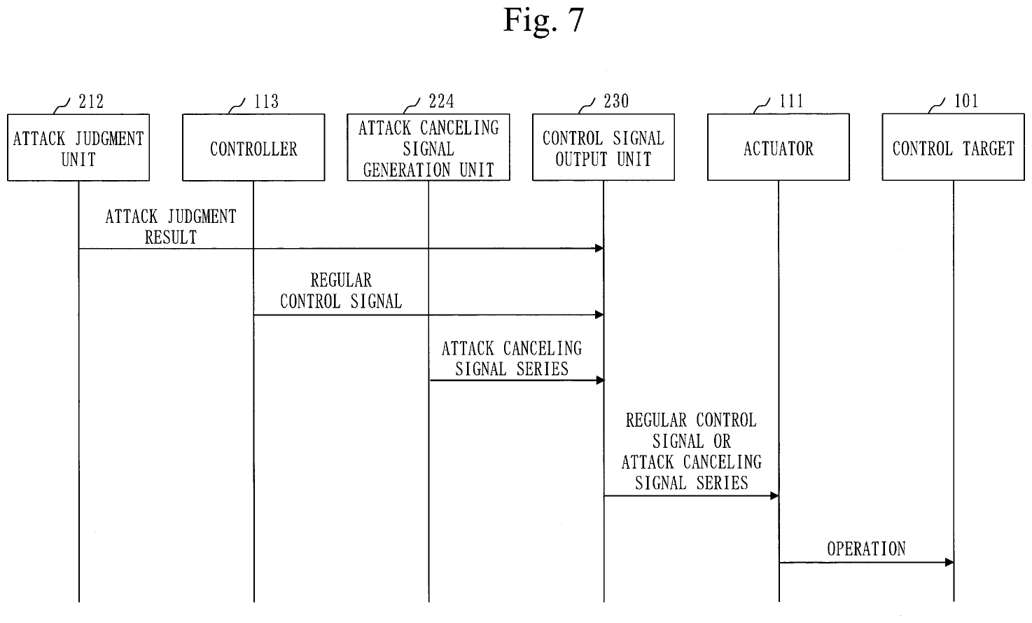

Operations of the control signal output unit 230 will be described with referring to FIG. 7.

The attack judgment result is inputted to the control signal output unit 230 at each time point from the attack judgment unit 212. The control signal output unit 230 accepts the inputted attack judgment result.

The regular control signal is inputted to the control signal output unit 230 at each time point from the controller 113. The control signal output unit 230 accepts the inputted regular control signal.

The attack canceling signal series is inputted to the control signal output unit 230 from the attack canceling signal generation unit 224. The control signal output unit 230 accepts the inputted attack canceling signal series.

The control signal output unit 230 selects one or the other of the regular control signal and the attack canceling signal series based on the attack judgment result. If the attack judgment result indicates “an attack does not exist”, the control signal output unit 230 selects the regular control signal.

If the attack judgment result indicates “attack exists”, the control signal output unit 230 selects the attack canceling signal series.

When the regular control signal is selected, the control signal output unit 230 outputs the regular control signal. The regular control signal outputted from the control signal output unit 230 is inputted to the actuator 111.

The actuator 111 accepts the inputted regular control signal and operates in accordance with the accepted regular control signal. Consequently, the actuator 111 operates on the control target 101, and the control target 101 changes its status.

When the attack canceling signal series is selected, the control signal output unit 230 outputs the attack canceling signal series. Specifically, the control signal output unit 230 outputs the attack canceling signal in the order it is outputted from the interim control signal generation unit 241, until a dummy signal is inputted from the interim control signal generation unit 241.

The attack canceling signal outputted from the control signal output unit 230 is inputted to the actuator 111.

The actuator 111 accepts the inputted attack canceling signal and operates in accordance with the accepted attack canceling signal. Consequently, the actuator 111 operates on the control target 101, and the control target 101 changes its status.

***Effect of Embodiment 1***

In Embodiment 1, a set of an attack start time point and a sensor data series, or a set of an attack start time point and an actuator control signal series, is used. Then, how the status of the control target 101 has been changed by the attack, or into what status the control target 101 has been put by erroneously performed control, is identified, and an attack canceling signal for performing control that restores the control target 101 to a normal status is generated. As a result, the control target 101 can be recovered from an abnormal status caused by an attack.

Sensor data and an actuator control signal may be inputted to the attack canceling device 200 from the control system 110. Therefore, the sensor 112 need not be processed. Also, the sensor 112 will not be influenced adversely.

The sensor 112 is not limited to a particular sensor. Embodiment 1 can be applied to a sensor 112, such as a temperature sensor, an optical sensor, and a pressure sensor, other than the inclination sensor which has been given as an example. No special condition, for example, the sensor 112 must be able to be set with a sampling period, is imposed.

The attack canceling device 200 generates an attack canceling signal utilizing abnormal sensor data or an abnormal actuator control signal. Therefore, even in a situation where normal sensor data cannot be utilized at all, the control target 101 can be recovered from an abnormal status resulting from an attack.

***Other Configurations***

Each of the attack detection unit 210 and the attack canceling unit 220 may be provided with an attack score calculation unit (211).

The individual attack score calculation units (211) may calculate attack scores by the same method or by different methods.

The attack judgment unit 212 uses an attack score calculated by the attack score calculation unit 211 of the attack detection unit 210.

The attack start time point identification unit 223 uses an attack score calculated by the attack score calculation unit of the attack canceling unit 220.

The attack canceling device 200 and the controller 113 may be unified. The attack canceling device 200 may be composed of a plurality of devices.

For example, the attack detection unit 210 may be implemented by an external attack detection device.

When the attack canceling signal is generated by the <First Method>, the attack canceling device 200 need not be provided with a control signal storage unit 222.

### Embodiment 2

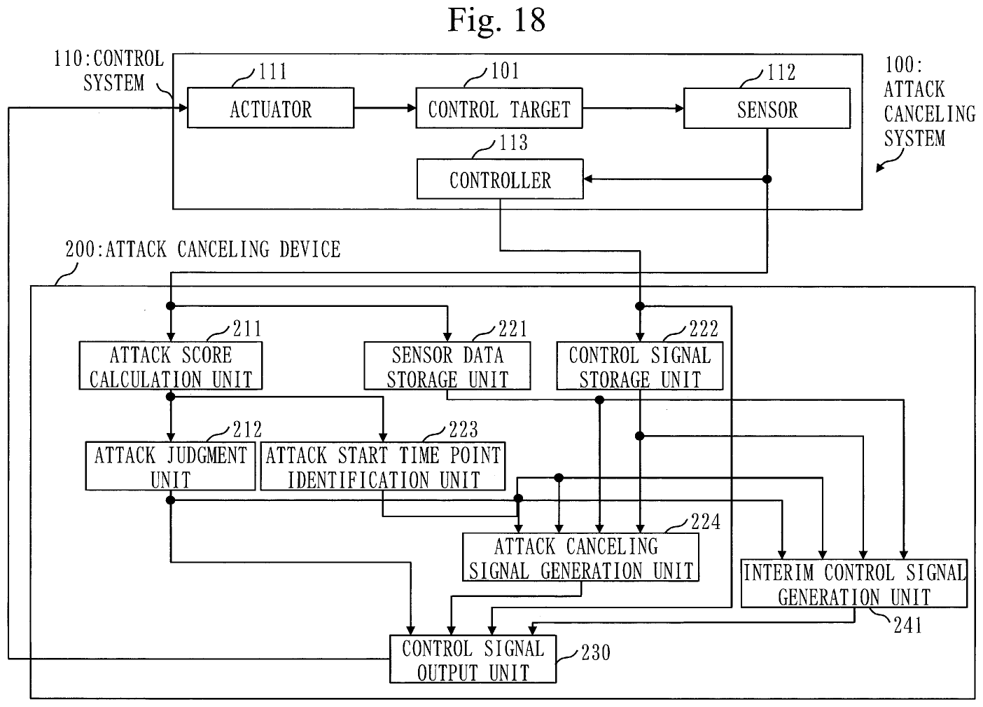

An embodiment to handle an attack continuing even after the control target 101 is recovered from an abnormal status will be described mainly regarding a difference from Embodiment 1, with referring to FIGS. 18 to 25.

***Description of Configurations*** A configuration of an attack canceling system 100 will be described with referring to FIG. 18.

The attack canceling system 100 is provided with a control system 110 and an attack canceling device 200, as described in Embodiment 1.

The attack canceling device 200 is provided with an interim control signal generation unit 241 in addition to the elements described in Embodiment 1.

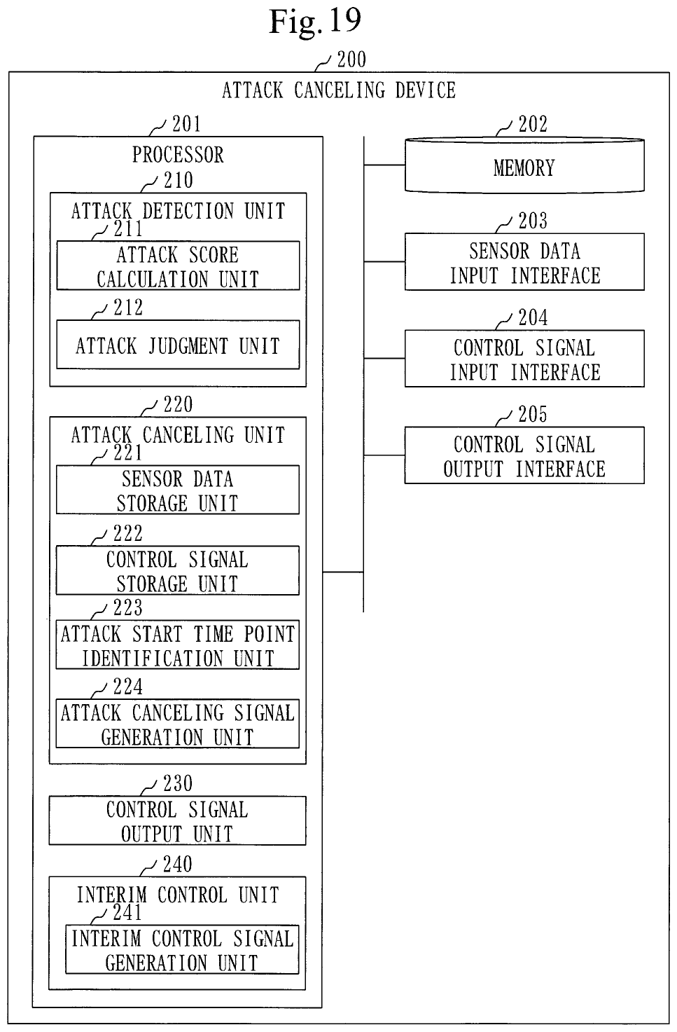

A configuration of the attack canceling device 200 will be described with referring to FIG. 19.

The attack canceling device 200 is provided with an interim control unit 240 in addition to the elements described in Embodiment 1.

The interim control unit 240 is provided with the interim control signal generation unit 241.

An attack canceling program further causes the computer to function as the interim control unit 240.

***Description of Operations***

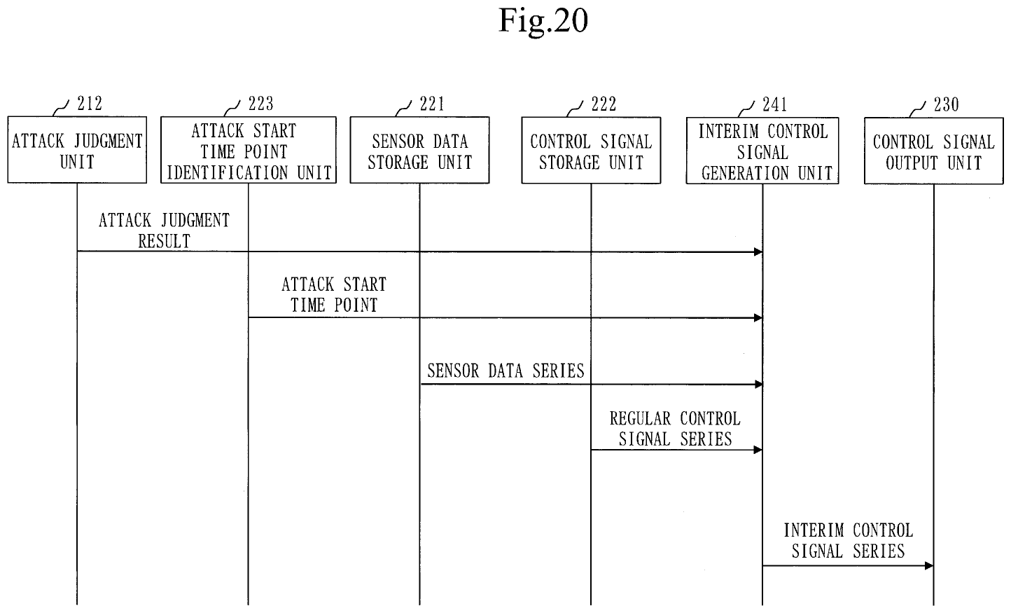

Operations of the interim control signal generation unit 241 will be described with referring to FIG. 20.

An attack judgment result is inputted to the interim control signal generation unit 241 at each time point from an attack judgment unit 212. The interim control signal generation unit 241 accepts the inputted attack judgment result.

An attack start time point is inputted to the interim control signal generation unit 241 at each time point from an attack start time point identification unit 223. The interim control signal generation unit 241 accepts the inputted attack start time point.

A sensor data series is inputted to the interim control signal generation unit 241 from a sensor data storage unit 221. The interim control signal generation unit 241 accepts the inputted sensor data series.

A regular control signal series is inputted to the interim control signal generation unit 241 from a control signal storage unit 222. The interim control signal generation unit 241 accepts the inputted regular control signal series.

The interim control signal generation unit 241 generates an interim control signal series based on the attack judgment result, the attack start time point, the sensor data series, and the regular control signal series.

The interim control signal series is a predictive actuator control signal series of a case where an attack on a sensor 112 is not made.

The interim control signal series is composed of one interim control signal or more lining up on the time base.

The interim control signal is a predicted normal actuator control signal.

Note that the interim control signal generation unit 241 generates the interim control signal series using one or the other of the sensor data series and the regular control signal series.

A method that uses the sensor data series and not the regular control signal series will be called a [First Method].

A method that uses the regular control signal series and not the sensor data series will be called a [Second Method].

The [First Method] will be described.

In the [First Method], a future series is predicted based on a normal sensor data series, and an actuator control signal series corresponding to the predicted sensor data series is generated. The actuator control signal series to be generated is the interim control signal series.

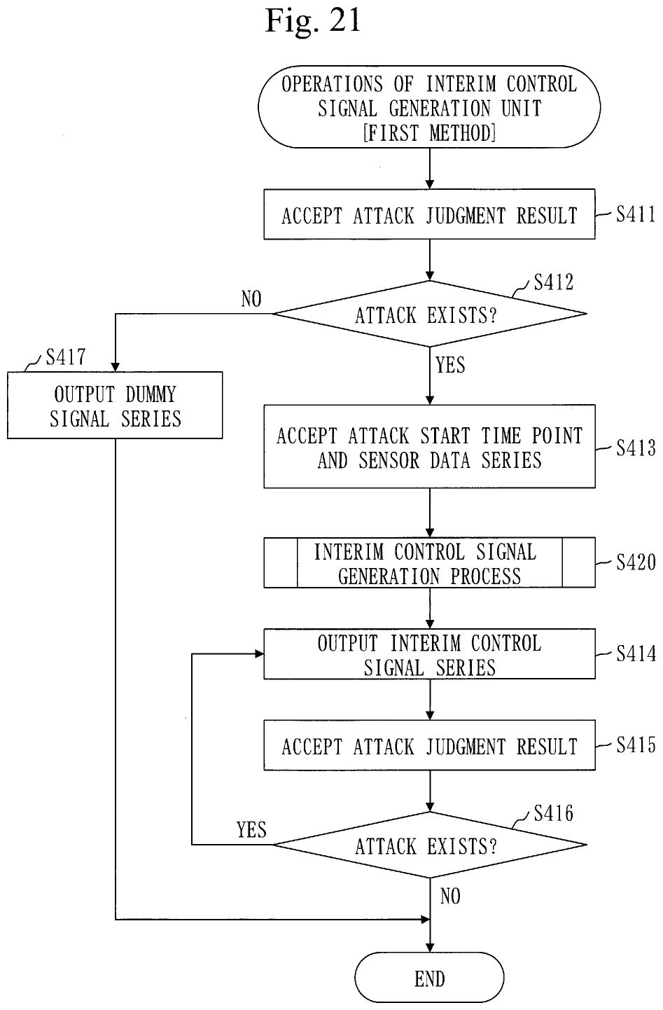

A procedure of the [First Method] will be described with referring to FIG. 21.

In step S411, the interim control signal generation unit 241 accepts an attack judgment result.

In step S412, the interim control signal generation unit 241 judges whether or not an attack exists based on the attack judgment result.

If it is judged that “an attack exists”, the processing proceeds to step S413.

If it is judged that “an attack does not exist”, the processing proceeds to step S417.

In step S413, the interim control signal generation unit 241 accepts an attack start time point and a sensor data series.

In step S420, the interim control signal generation unit 241 generates an interim control signal series based on the attack start time point and the sensor data series.

A procedure of an interim control signal generation process (S420) will be described later.

In step S414, the interim control signal generation unit 241 outputs the interim control signal series.

Specifically, the interim control signal generation unit 241 outputs one interim control signal or more included in the interim control signal series, one by one in the time-base order.

In step S415, the interim control signal generation unit 241 accepts a next attack judgment result.

In step S416, the interim control signal generation unit 241 judges whether or not an attack exists based on the next attack judgment result.

If it is judged that “an attack exists”, the processing proceeds to step S414. If it is judged that “an attack does not exist”, the processing ends.

In step S417, the interim control signal generation unit 241 outputs a dummy signal series as the interim control signal series.

The dummy signal series is composed of one dummy value or more. The dummy value may take any value. For example, the dummy value is “0”.

After step S417, the processing ends.

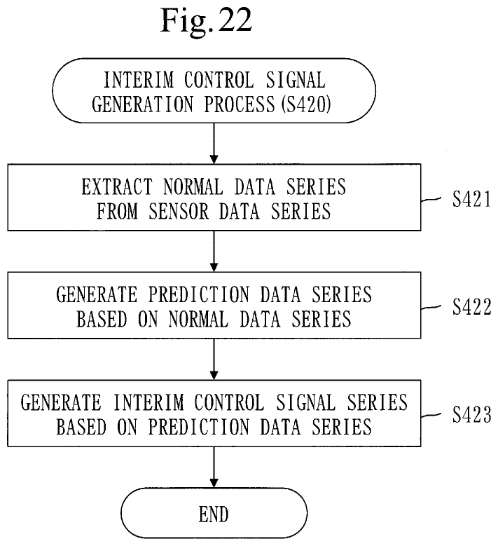

The procedure of the interim control signal generation process (S420) will now be described with referring to FIG. 22.

In step S421, the interim control signal generation unit 241 extracts a sensor data series of before the attack start time point, from the accepted sensor data series.

The sensor data series to be extracted will be referred to as a “normal data series”.

In step S422, the interim control signal generation unit 241 executes a prediction algorithm on the normal data series. Consequently, a prediction data series is generated.

The prediction algorithm is an algorithm for predicting a future sensor data series based on a past sensor data series.

The prediction data series is a predictive sensor data series of since the attack start time point.

As the prediction algorithm, regression analysis can be given. The regression analysis is used frequently as time-series data analysis.

For example, a SARIMA model is estimated by the prediction algorithm based on the normal data series. Then, a prediction data series is generated based on the SARIMA model. Note that SARIMA stands for Seasonal Autoregressive Integrated Moving Average.

Sensor data of since the attack start time point can also be utilized so long as it has not been completely abnormalized. The interim control signal generation unit 241 may partly extract information that can be utilized for controlling an actuator 111, from sensor data of since the attack start time point, and may utilize the extracted information (information of a normal portion).

For example, assume it is known that an attack will only bias each sensor data. In this case, the interim control signal generation unit 241 compares an extracted sensor data series with a past sensor data series, removes the bias from the extracted sensor data series based on a comparison result, and generates a prediction data series based on the sensor data series from which the bias has been removed.

For example, if an attack is being made on a value along one axis among values of three axes indicated by individual sensor data, the interim control signal generation unit 241 may utilize values along the remaining two axes expressed by the individual sensor data.

In step S423, the interim control signal generation unit 241 executes a control algorithm on the prediction data series. An actuator control signal series generated by this execution is the interim control signal series.

The control algorithm executed in step S423 is the same as the control algorithm in the controller 113.

The [Second Method] will be described.

In the [Second Method], a future actuator control signal series is predicted based on a normal actuator control signal series. The predicted actuator control signal series is the interim control signal series.

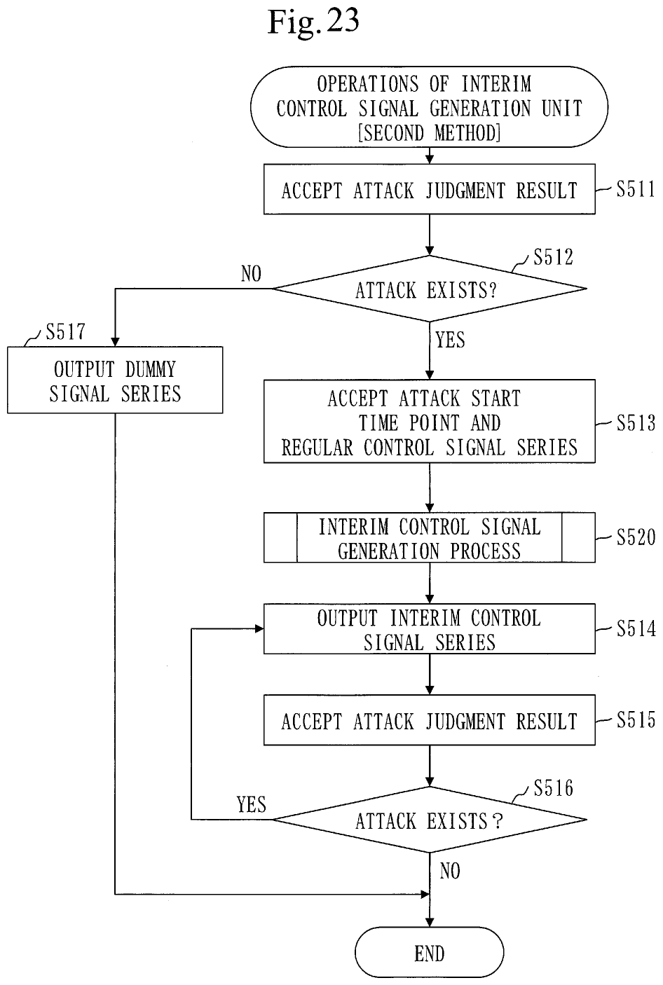

A procedure of the [Second Method] will be described with referring to FIG. 23.

In step S511, the interim control signal generation unit 241 accepts an attack judgment result.

In step S512, the interim control signal generation unit 241 judges whether or not an attack exists based on the attack judgment result.

If it is judged that “an attack exists”, the processing proceeds to step S513.

If it is judged that “an attack does not exist”, the processing proceeds to step S517.

In step S513, the interim control signal generation unit 241 accepts an attack start time point and a regular control signal series.

In step S520, the interim control signal generation unit 241 generates an interim control signal series based on the attack start time point and the regular control signal series.

A procedure of an interim control signal generation process (S520) will be described later.

In step S514, the interim control signal generation unit 241 outputs the interim control signal series.

Specifically, the interim control signal generation unit 241 outputs one interim control signal or more included in the interim control signal series, one by one in the time-base order.

In step S515, the interim control signal generation unit 241 accepts a next attack judgment result.

In step S516, the interim control signal generation unit 241 judges whether or not an attack exists based on the next attack judgment result.

If it is judged that “an attack exists”, the processing proceeds to step S514.

If it is judged that “an attack does not exist”, the processing ends.

In step S517, the interim control signal generation unit 241 outputs a dummy signal series as the interim control signal series.

The dummy signal series is composed of one dummy signal or more. The dummy value may take any value. For example, the dummy value is “0”.

After step S517, the processing ends.

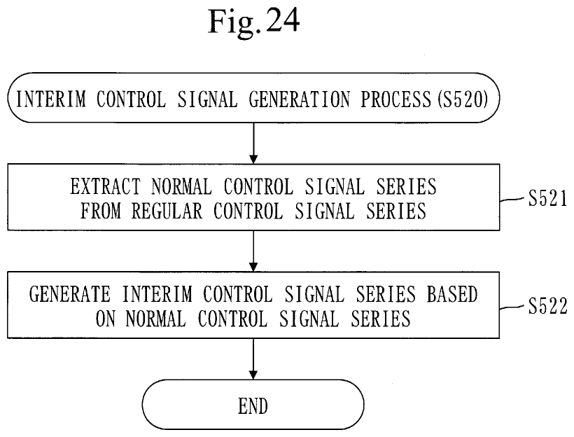

The procedure of the interim control signal generation process (S520) will now be described with referring to FIG. 24.

In step S521, the interim control signal generation unit 241 extracts a regular control signal series of before the attack start time point, from the accepted regular control signal series.

The regular control signal series to be extracted will be referred to as a “normal control signal series”.

In step S522, the interim control signal generation unit 241 executes a prediction algorithm on the normal control signal series. As a result, a prediction control signal series is generated. The prediction control signal series to be generated is the interim control signal series.

The prediction algorithm is an algorithm for predicting a future actuator control signal series based on a past actuator control series.

The prediction control signal series is a future actuator control signal series predicted based on the normal control signal series.

As the prediction algorithm, regression analysis can be given. The regression analysis is used frequently as time-series data analysis.

For example, a SARIMA model is estimated by the prediction algorithm based on the normal control signal series. Then, a prediction control signal series is generated based on the SARIMA model.

The interim control signal generation unit 241 may utilize the regular control signal series partly, just as in the [First Method] where the sensor data series is utilized partly.

Back to FIG. 20, the description of the interim control signal generation unit 241 will continue.

The interim control signal generation unit 241 outputs the generated interim control signal series.

The interim control signal series outputted from the interim control signal generation unit 241 is inputted to a control signal output unit 230.

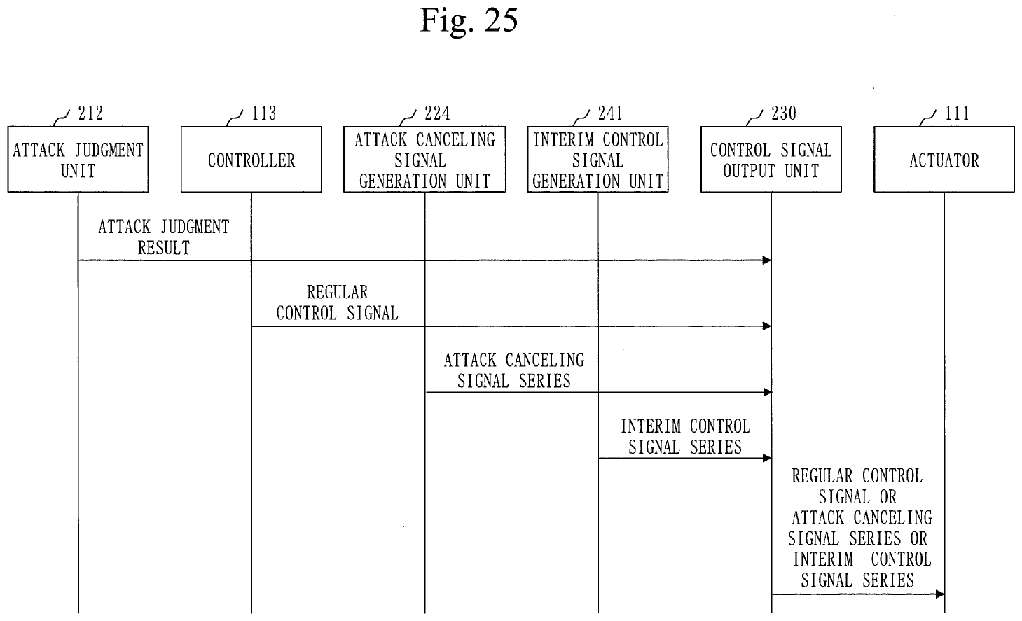

Operations of the control signal output unit 230 will be described with referring to FIG. 25.

The attack judgment result is inputted to the control signal output unit 230 at each time point from the attack judgment unit 212. The control signal output unit 230 accepts the inputted attack judgment result.

A regular control signal is inputted to the control signal output unit 230 at each time point from a controller 113. The control signal output unit 230 accepts the inputted regular control signal.

An attack canceling signal series is inputted to the control signal output unit 230 from an attack canceling signal generation unit 224. The control signal output unit 230 accepts the inputted attack canceling signal series.

The interim control signal series is inputted to the control signal output unit 230 from the interim control signal generation unit 241. The control signal output unit 230 accepts the inputted interim control signal series.

The control signal output unit 230 selects one or the other of the regular control signal and the set of the attack canceling signal series and the interim control signal series based on the attack judgment result.

If the attack judgment result indicates “an attack does not exist”, the control signal output unit 230 selects the regular control signal.

If the attack judgment result indicates “an attack exists”, the control signal output unit 230 selects the set of the attack canceling signal series and the interim control signal series.

When the regular control signal is selected, the control signal output unit 230 outputs the regular control signal. The regular control signal outputted from the control signal output unit 230 is inputted to the actuator 111.

The actuator 111 accepts the inputted regular control signal and operates in accordance with the accepted regular control signal. Consequently, the actuator 111 operates on a control target 101, and the control target 101 changes its status.

When the set of the attack canceling signal series and the interim control signal series is selected, the control signal output unit 230 outputs the attack canceling signal series and after that outputs the interim control signal series.

Specifically, the control signal output unit 230 outputs each attack canceling signal in the order it is outputted from the interim control signal generation unit 241, until a dummy signal is inputted from the interim control signal generation unit 241. During a period since output of the attack canceling signal series is started and until output of the interim control signal series ends, the control signal output unit 230 stores the interim control signal to a buffer in the order it is outputted from the interim control signal generation unit 241. After output of the attack canceling signal series ends, the control signal output unit 230 outputs each interim control signal in the order it is saved in the buffer.

Each attack canceling signal outputted from the control signal output unit 230 is inputted to the actuator 111. The actuator 111 accepts each inputted attack canceling signal and operates in accordance with each accepted attack canceling signal. Consequently, the actuator 111 operates on the control target 101, and the control target 101 changes its status.

Each interim control signal outputted from the control signal output unit 230 is inputted to the actuator 111. The actuator 111 accepts each inputted interim control signal and operates in accordance with each accepted interim control signal.

Consequently, the actuator 111 operates on the control target 101, and the control target 101 changes its status.

***Effect of Embodiment 2***

If the attack on the sensor 112 continues even after the control target 101 is recovered from the influence of the attack, the attack canceling device 200 operates the actuator 111 by the interim control signal. Hence, even in a situation where the sensor 112 cannot be utilized due to the attack, control on the control target 101 can be continued.

***Supplement to Embodiments***

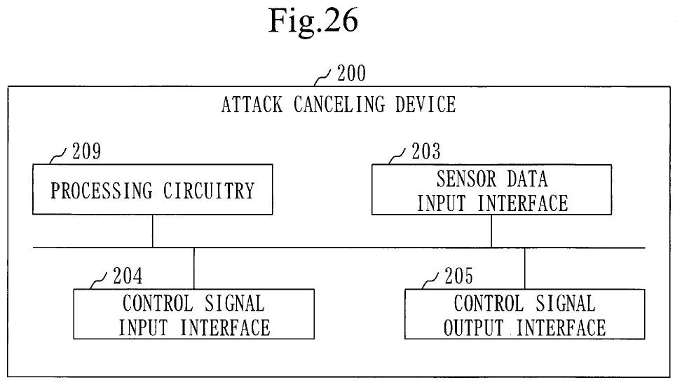

A hardware configuration of the attack canceling device 200 will be described with referring to FIG. 26.

The attack canceling device 200 is provided with processing circuitry 209.

The processing circuitry 209 is a hardware device that implements the attack detection unit 210, the attack canceling unit 220, the control signal output unit 230, and the interim control unit 240.

The processing circuitry 209 may be dedicated hardware, or may be a processor 201 that executes the program stored in the memory 202.

When the processing circuitry 209 is dedicated hardware, the processing circuitry 209 is, for example, a single circuit, a composite circuit, a programmed processor, a parallel-programmed processor, an ASIC, or an FPGA; or a combination of a single circuit, a composite circuit, a programmed processor, a parallel-programmed processor, an ASIC, and an FPGA.

Note that ASIC stands for Application Specific Integrated Circuit, and FPGA stands for Field Programmable Gate Array.

The attack canceling device 200 may be provided with a plurality of processing circuitries to substitute for the processing circuitry 209. The plurality of processing circuitries share a role of the processing circuitry 209.

In the attack canceling device 200, some of the functions may be implemented by dedicated hardware, and the remaining functions may be implemented by software or firmware.

In this manner, the processing circuitry 209 can be implemented by hardware, software, or firmware; or a combination of hardware, software, and firmware.

The embodiments are exemplifications of preferable modes and are not intended to limit the technical scope of the present invention. Each embodiment may be practiced partially, or may be practiced in combination with another embodiment.

The procedures described with using flowcharts or the like may be changed as necessary.

A “unit” being an element of the attack canceling device 200 may be replaced by a “circuit”, a “stage”, a “procedure”, or a “process”.

### REFERENCE SIGNS LIST

100: attack canceling system; 101: control target; 110: control system; 111: actuator; 112: sensor; 113: controller; 200: attack canceling device; 201: processor; 202: memory; 203: sensor data input interface; 204: control signal input interface; 205: control signal output interface; 209: processing circuitry; 210: attack detection unit; 211: attack score calculation unit; 212: attack judgment unit; 220: attack canceling unit; 221: sensor data storage unit; 222: control signal storage unit; 223: attack start time point identification unit; 224: attack canceling signal generation unit; 230: control signal output unit; 240: interim control unit; 241: interim control signal generation unit.

1. An attack canceling device comprising:
processing circuitry
to identify an attack start time point at which an attack is started on a sensor that outputs sensor data of each time point, based on the sensor data of each time point, the sensor data of each time point expressing a status at each time point of a control target on which an actuator operates, and
to generate an attack canceling signal series, being an actuator control signal series for restoring the status of the control target to a status of a time point that is before the attack start time point, based on at least one or the other of a sensor data series of since the attack start time point and an actuator control signal series of since the attack start time point.

2. The attack canceling device according to claim 1,
wherein the processing circuitry converts the sensor data series of since the attack start time point into an attack canceling data series in which individual sensor data values are inverted with respect to a criterion value and an order of the individual sensor data values on a time base is reversed, and generates the attack canceling signal series based on the attack canceling data series.

3. The attack canceling device according to claim 1,
wherein the processing circuitry estimates the status of the control target based on the actuator control signal series of since the attack start time point, and generates the attack canceling signal series based on a status change amount of from a status expressed by sensor data of the time point that is before the attack start time point, to the estimated status.

4. The attack canceling device according to claim 1,
wherein the processing circuitry
converts the sensor data series of since the attack start time point into an attack canceling data series in which individual sensor data values are inverted with respect to a criterion value and an order of the individual sensor data values on a time base is reversed, and generates a first candidate series as the attack canceling signal series based on the attack canceling data series,
estimates the status of the control target based on the actuator control signal series of since the attack start time point, and generates a second candidate series as the attack canceling signal series based on a status change amount of from a status indicated by sensor data of the time point that is before the attack start time point, to the estimated status, and
generates the attack canceling signal using the first candidate series and the second candidate series.

5. The attack canceling device according to claim 1,
wherein the processing circuitry
detects an attack on the sensor based on the sensor data of each time point, and
identifies a time point that is earlier than the attack detection time point, as the attack start time point by using a criterion lower than a detection criterion.

6. The attack canceling device according to claim 1,
wherein the processing circuitry generates an interim control signal series, being a predictive actuator control signal series of a case where an attack on the sensor is not made, based on an inputted sensor data series or an inputted actuator control signal series.

7. The attack canceling device according to claim 6,
wherein the processing circuitry generates a predictive sensor data series of since the attack start time point based on a sensor data series of before the attack start time point, and generates the interim control signal series based on the generated predictive sensor data series.

8. The attack canceling device according to claim 6,
wherein the processing circuitry extracts information that can be utilized for controlling the actuator, from the sensor data series of since the attack start time point, generates a predictive sensor data series of since the attack start time point based on the extracted information, and generates the interim control signal series based on the generated predictive sensor data series.

9. The attack canceling device according to claim 6,
wherein the processing circuitry generates the interim control signal series based on an actuator signal series of before the attack start time point.

10. An attack canceling method comprising:
identifying an attack start time point at which an attack is started on a sensor that outputs sensor data of each time point, based on the sensor data of each time point, the sensor data of each time point expressing a status at each time point of a control target on which an actuator operates; and
generating an attack canceling signal series, being an actuator control signal series for restoring the status of the control target to a status of a time point that is before the attack start time point, based on at least one or the other of a sensor data series of since the attack start time point and an actuator control signal series of since the attack start time point.

11. A non-transitory computer readable medium recorded with an attack canceling program which causes a computer to execute:
an attack start time point identification process of identifying an attack start time point at which an attack is started on a sensor that outputs sensor data of each time point, based on the sensor data of each time point, the sensor data of each time point expressing a status at each time point of a control target on which an actuator operates; and
an attack canceling signal generation process of generating an attack canceling signal series, being an actuator control signal series for restoring the status of the control target to a status of a time point that is before the attack start time point, based on at least one or the other of a sensor data series of since the attack start time point and an actuator control signal series of since the attack start time point.
